(19) United States
(12) Patent Application Publication
(10) Pub. No.: US 2009/0087821 A1
(43) Pub. Date: Apr. 2, 2009

(54) Digital language teaching system

(75) Inventors: Kuang-Lieh Cheng, Taichung (TW); Erh-Pei Huang, Taichung (TW); Rai-Lin Chen, Taichung (TW); Hung-Chao Chiang, Taichung (TW); Cheng-Kai Huang, Taichung (TW)

Correspondence Address: Joe McKinney Muncy, PO Box 1364, Fairfax, VA, 22038-1364, US

(73) Assignee: KUANG CHIEN COMPUTER CO., LTD.

(21) Appl. No.: 11/905,135

(22) Filed: Sep. 27, 2007

(51) Int. Cl. G09B 19/00

(52) U.S. Cl. 434/156

(57) ABSTRACT

A digital language teaching system is disclosed, in which through an audio control manner, the learner, by utilizing a learning sub-machine, can focus on listening and speaking practice under a simple hardware control and operation, so that the teaching staff and the learner can have a more direct and faster interaction for improving learning efficiency. Moreover, through the output devices of the video device and teaching providing the learner the teaching image and the interactive teaching pictures, the video learning manner can be provided to the learner through the supplemental multimedia teaching materials, so that the teaching staff can teach the learners in accordance with their aptitudes, and the learner can find the most suitable learning method.

### FIELD OF THE INVENTION

The present invention is related to a digital language teaching system, and more particularly to a language teaching system which utilizes a simple hardware control and operation manner to provide different learning equipments to different learners for conforming different demands, so as to improve learning efficiency of the learners.

### BACKGROUND OF THE INVENTION

Owing to technology developments, economic globalization and the more and more frequent communications between people, people all over the world have more and more chances to communicate with people in other countries, so that learning different languages (foreign languages) becomes more and more important for modern people, especially in speaking and listening.

For listening, the main purpose is to develop the phonetic coding ability, that is, to listen clearly what others are saying and understand the meaning thereof, so that the training of listening is to enable the learner to follow the pronunciation, be familiar to the mood, speed and tone, and then understand the foreign language.

For speaking, if one wants to speak correctly and to let others understand what he or she says, the pronunciation thereof has to be enhanced, namely, the phonetic imitation should be practiced again and again.

Generally, except one-on-one teaching which provides the learner and the teaching staff the opportunity to interact with each other, the language teachings of listening and speaking in other styles are difficult to let every learner have the chance to practice.

For electronic teaching system, although one user can be equipped with one machine and the learning can be achieved by distance instruction through internet, the distance instruction is still achieved by one-way data provision from the teaching staff and the learner can not actively transmit data to or obtain data from the teaching staff instantly. The advanced method is to provide two-way multimedia communication and interaction for enriching the learning contents, but the learning effect is still limited by the operation which should be achieved by the hardware equipments, such as mouse and keyboard. The general learners might be most likely the students or the language-learning beginners and not familiar to computer commands and operations, so that if the learning which needs the learners to totally pay attention is interrupted by the extra memorization of computer operation, such as commands, or the eyes should focus on the display in front thereof or of the classroom, the learners might not be able to concentrate on the learning. Therefore, this kind of learning method is not suitable for the beginner or who wants to focus or needs to particularly enhance the learning of speaking and listening.

Each kind of electronic teaching system has its own efficiency but it also means the single function thereof, so that the teaching staff can not effectively adjust the teaching manner according to different levels and demands from different learners.

### SUMMARY OF THE INVENTION

For solving the drawbacks described above, the purpose of the present invention is to provide a digital language teaching system which can make the user to concentrate on listening and speaking under a simple hardware control and operation, and the interaction between the teaching staff and the learner can be more direct and faster, and also the learning efficiency of the learner can be improved.

Another object of the present invention is to provide a digital language teaching system which can group different kinds of equipments for different demands, so that the expense of equipments can be reduced. Besides, the learner can improve the learning efficiency thereof depending on the level thereof under a proper support of learning equipment.

For achieving the objects described above, the present invention provides a digital language teaching system including an audio control mainframe for controlling and managing audio inputs and outputs, a teaching mainframe used by a teaching staff to manage the audio control mainframe, a teaching sub-machine connected to the audio control mainframe for being used by the teaching staff to receive, listen and record sound, and plural learning sub-machines connected to the audio control mainframe by group so as to be used by each learner to receive, listen and record sound. The teaching staff can listen to the voice file recorded by the learner in the learning submachine through the teaching sub-machine, and the teaching staff also can imitate the telephone conversation with the learning sub-machines through the teaching sub-machine so as to provide a life-style conversation training.

Preferably, the teaching sub-machine and the learning sub-machines both further include a headset for providing the teaching staff and the learners the exclusive sound receiving and sending instrument.

Moreover, the teaching mainframe is further provided with a video signal from one of a teaching material data base and a broadcasting device through a video switching control system, and the sound from the teaching material data base and the broadcasting device is supplied to the audio control mainframe.

Furthermore, the teaching mainframe shows the teaching image through a large-scale video device and is connected to a loud speaker through the audio control mainframe.

Furthermore, the teaching mainframe is connected to plural interactive sub-machines, each of which has a display, for providing each learner on the displays a simultaneous teaching image and teaching pictures of interactive keyboard and mouse operation. Besides, the teaching mainframe also can be connected to plural computers, each of which has a display, for providing each learner on the displays a simultaneous teaching image and teaching pictures of interactive keyboard and mouse operation through utilizing the multimedia function and multiplexing ability of the computer. Therefore, the teaching staff can teach the learners in accordance with their aptitudes, and the learner can find the most suitable learning method.

The present invention is advantageous that through audio control, the learner can focus on listening and speaking practice under a simple hardware control and operation which is achieved by the learning sub-machine, so that the teaching staff and the learner can have a more direct and faster interaction for improving learning efficiency.

In addition, through the output devices of video device and teaching image providing the learner the teaching image and the interactive teaching pictures, the video learning manner can be provided to the learner through the supplemental multimedia teaching materials, so that the teaching staff can teach the learners in accordance with their aptitudes, and the learner can find the most suitable learning method. Consequently, learners with different learning demands can cooperate with different equipments for reducing the expense, and further, the learner can choice course and learning equipment according to the level thereof, so as to improve learning efficiency.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows the system architecture of the present invention.

### DESCRIPTION OF THE PREFERRED EMBODIMENT

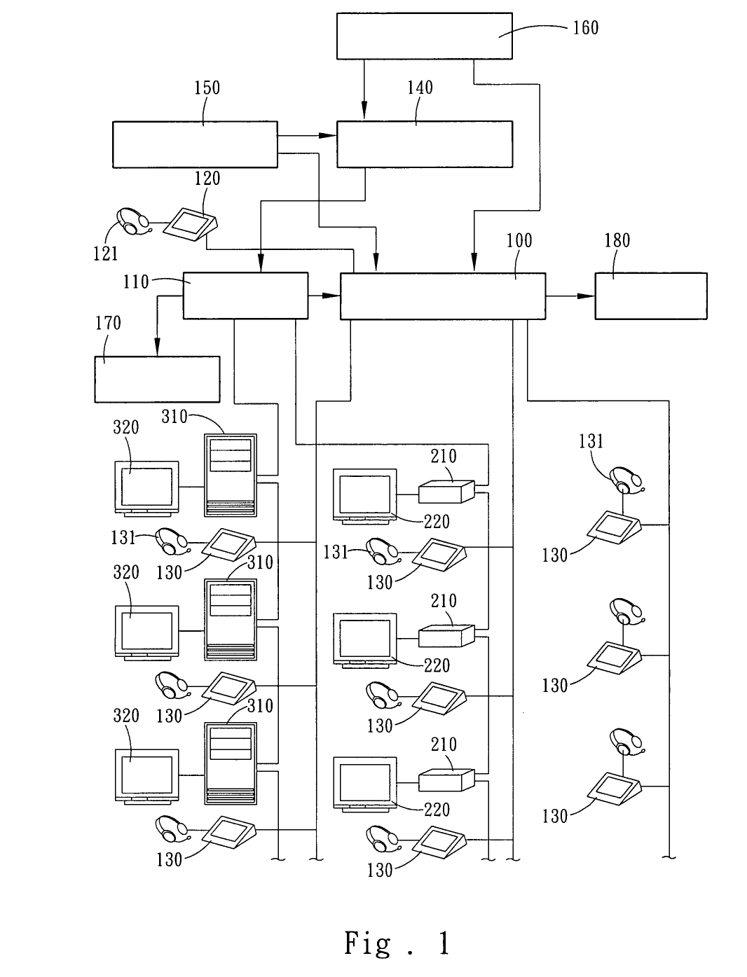

Please refer to FIG. 1, which shows the system architecture of the present invention. The present invention includes an audio control mainframe 100 for controlling and managing the audio inputs and outputs of the teaching staff, the learner and the peripheral equipment, a teaching mainframe 110 used by the teaching staff to manage the audio control mainframe 100, a teaching sub-machine 120 connected to the audio control mainframe 100 for being used by the teaching staff to receive sound, listen and record, to transmit the voice and receive the voice from the learner, and also to edit and record the sound for sharing to learners, and plural learning sub-machines 130 connected to the audio control mainframe 100 by group so as to provide each learner one sub-machine for receiving sound, listening and recording.

The teaching staff can listen to the voice file recorded by the learner in the learning sub-machine 130 through the teaching sub-machine 120, and the teaching staff also can imitate the telephone conversation with the learning sub-machines 130 through the teaching sub-machine 120 so as to provide a life-style conversation training, thereby the learner can concentrate on listening and speaking through this pure language conversation.

Moreover, the teaching sub-machine 120 further includes a headset 121 and each of the learning sub-machines 130 also includes a headset 131, so that the teaching staff and each the learners all have an exclusive audio receiving and sending instrument, thereby the learners will not interfere with each other.

When using, the teaching mainframe 110 can be further provided with video signal from one of a teaching material data base 150 and a broadcasting device 160 through a video switching control system 140, so as to obtain the video signal of multimedia teaching material. Of course, the sounds from the teaching material database 150 and the broadcasting device 160 are also inputted into the audio control mainframe 100 for managing and control, so that different learning groups can be provided by different video teaching.

Therefore, the teaching mainframe 110 can further show the teaching image through a large-scale video device 170, and through the audio control mainframe 100 connecting to a loud speaker 180, the speech can be broadcasted, which is suitable for one to multiple teaching in large space.

The teaching mainframe 110 can be further connected to plural interactive sub-machines 210, each of which has a display 220, for providing each learner on the displays 220 a simultaneous teaching image and teaching pictures of interactive keyboard and mouse operation, thereby the learner also can learn through the multimedia teaching materials. Besides, the teaching mainframe 110 also can be connected to plural computers 310, each of which has a display 320, for providing each learner on the displays 320 a simultaneous teaching image and teaching pictures of interactive keyboard and mouse operation through utilizing the multimedia function and multiplexing ability of the computer. Therefore, the teaching staff can teach the learners in accordance with their aptitudes, and the learner can find the most suitable learning method.

The present invention is advantageous that through audio control, the learner can focus on listening and speaking practice under a simple hardware control and operation which is achieved by the learning sub-machine 130, so that the teaching staff and the learner can have a more direct and faster interaction for improving learning efficiency. Moreover, through the output devices of video device and teaching image providing the learner the teaching image and the interactive teaching pictures, the video learning manner can be provided to the learner through the supplemental multimedia teaching materials, so that the teaching staff can teach the learners in accordance with their aptitudes, and the learner can find the most suitable learning method. Consequently, learners with different learning demands can cooperate with different equipments for reducing the expense, and further, the learner can choice course and learning equipment according to the level thereof, so as to improve learning efficiency.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A digital language teaching system, comprising:
an audio control mainframe for controlling and managing audio inputs and outputs;
a teaching mainframe used by a teaching staff to manage the audio control mainframe;
a teaching sub-machine connected to the audio control mainframe for being used by the teaching staff to receive, listen and record sound; and
plural learning sub-machines connected to the audio control mainframe by group so as to be used by each learner to receive, listen and record sound.

2. The digital language teaching system as claimed in claim 1, wherein the teaching sub-machine and the learning sub-machines each includes a headset for listening and receiving sound.

3. The digital language teaching system as claimed in claim 1, wherein the teaching staff listens to voice files recorded by the learners in the teaching sub-machines through the teaching sub-machine.

4. The digital language teaching system as claimed in claim 1, wherein the teaching staff imitates a telephone conversation with the learning sub-machines through the teaching sub-machine.

5. The digital language teaching system as claimed in claim 1, wherein the teaching mainframe is further provided with a video signal from one of a teaching material data base and a broadcasting device through a video switching control system, and the sound from the teaching material data base and the broadcasting device is supplied to the audio control mainframe.

6. The digital language teaching system as claimed in claim 1, wherein the teaching mainframe shows the teaching image through a large-scale video device and is connected to a loud speaker through the audio control mainframe.

7. The digital language teaching system as claimed in claim 1, wherein the teaching mainframe is connected to plural interactive sub-machines, each of which has a display, for providing each learner on the displays a simultaneous teaching image and teaching pictures of interactive keyboard and mouse operation.

8. The digital language teaching system as claimed in claim 1, wherein the teaching mainframe is further connected to plural computers, each of which has a display, for providing each learner on the displays a simultaneous teaching image and teaching pictures of interactive keyboard and mouse operation.
